(19) United States
(12) Patent Application Publication
(10) Pub. No.: US 2022/0180135 A1
(43) Pub. Date: Jun. 9, 2022

(54) SWITCH FROM SLEEP MODE TO MANUAL STAPLING OPERATION MODE

(71) Applicant: Hewlett-Packard Development Company, L.P., Spring, TX (US)

(72) Inventors: Mingi Kim, Pangyo (KR); Hyunsoo Song, Pangyo (KR)

(73) Assignee: Hewlett-Packard Development Company, L.P., Spring, TX (US)

(21) Appl. No.: 17/299,752

(22) PCT Filed: Jan. 31, 2020
(86) PCT No.: PCT/US2020/016123

§ 371 Date: Jun. 3, 2021

(30) Foreign Application Priority Data
Aug. 29, 2019 (KR) 10-2019-0106312

(51) Int. Cl. G06K 15/00

(52) U.S. Cl. CPC G06K 15/404

(57) ABSTRACT

An example post-processing apparatus includes an input unit to receive a request for a manual stapling operation, a stapling device, a switch to control power supplied from an image forming apparatus in a sleep mode to the stapling device, a sensor to detect print media being input to the post-processing apparatus, and a processor. The processor is to receive power from the image forming apparatus, which is in the sleep mode, control the switch to switch the post-processing apparatus from the sleep mode to a manual stapling operation mode when a request for a manual stapling operation is received via the input unit, and operate the stapling device when an input detection signal regarding the print media is received from the sensor.

### BACKGROUND

To reduce power consumption, an image forming apparatus such as a printer, a copier, a scanner, a facsimile, a multifunction printer, or the like, may be switched to a sleep mode when an event such as a user's operation does not occur for a certain period of time in a stand-by mode for a job request.

An accessory device is a collective term for a device that is connected to an image forming apparatus to increase user convenience by enhancing or supplementing a function of the image forming apparatus or expanding a function of the image forming apparatus. The accessory device connected to the image forming apparatus may also be switched from a stand-by mode to a sleep mode to save power.

### BRIEF DESCRIPTION OF THE DRAWINGS

FIG. 1 is a diagram showing an image forming apparatus including a post-processing apparatus according to an example;

FIG. 2 is a structural block diagram of an image forming apparatus and a post-processing apparatus according to an example

FIG. 3 is a structural block diagram of a stapling device according to an example;

FIG. 4 is a diagram for describing an operation of an image forming apparatus and a post-processing apparatus according to an example;

FIG. 5 is a flowchart of a method of controlling a post-processing apparatus according to an example;

FIG. 6 is a flowchart of a method of switching to a manual stapling operation mode according to an example;

FIG. 7 is a flowchart of a method of switching to a sleep mode according to an example;

FIG. 8 is a structural block diagram of an image forming apparatus and a post-processing apparatus according to an example;

FIG. 9 is a diagram for describing an operation of an image forming apparatus and a post-processing apparatus according to an example;

FIG. 10 is a flowchart of a method of switching to a manual stapling operation mode according to an example; and

FIG. 11 is a flowchart of a method of switching to a sleep mode according to an example.

### DETAILED DESCRIPTION OF EXAMPLES

Hereinafter, various examples will be described with reference to the accompanying drawings. In addition, in the present specification and drawings, components having substantially the same functional configuration are labeled with the same reference numerals to omit repeated description.

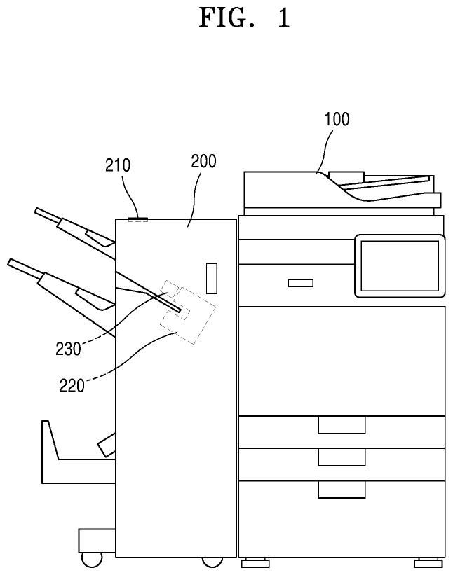

FIG. 1 is a diagram showing an image forming apparatus including a post-processing apparatus according to an example.

Referring to FIG. 1, an image forming apparatus 100 is a collective term for an apparatus capable of performing an image forming job, such as a printer, a copier, a scanner, a facsimile, a multi-function printer, or the like. An image forming job may refer to any of various jobs related to an image, for example, printing, copying, scanning, or faxing, and may include a series of processes required to perform an image forming job. The image forming apparatus 100 may receive a request for an image forming job and perform the requested image forming job.

A post-processing apparatus 200, which may also be referred to as a finisher, is connected to the image forming apparatus 100 as an accessory device. As illustrated in FIG. 1, the post-processing apparatus 200 may include a stapling device 220 to perform a stapling operation on print media. A stapling operation refers to binding multiple print media to fix the same by using a staple such as a metal fastener. By using the stapling device 220, the post-processing apparatus 200 may perform a post-process such as stapling print media, on which an image forming job is completed in the image forming apparatus 100.

The image forming apparatus 100 and the post-processing apparatus 200 may be switched from a certain operation mode or a stand-by mode to a sleep mode to reduce power consumption. When a user desires to use the image forming apparatus 100 or the post-processing apparatus 200 that has been switched to the sleep mode, the image forming apparatus 100 and the post-processing apparatus 200 may be switched from the sleep mode to the stand-by mode or the certain operation mode.

In the sleep mode, power supply to some components of an electronic device may be blocked (i.e., stopped) to reduce power consumption of the electronic device. The sleep mode may be a power mode in which power consumption of an electronic device is reduced when a user is not using the electronic device. For example, in the sleep mode, components with low power consumption may be in an on state, and components with high power consumption may be in an off state. Thus, in the sleep mode, low power may be supplied to some hardware components, that is, only to components with low power consumption.

While both the image forming apparatus 100 and the post-processing apparatus 200 are in the sleep mode, it may be desired to use a stand-alone function of the post-processing apparatus 200 connected to the image forming apparatus 100. However, if the sleep mode of the image forming apparatus 100 is terminated in order to use the stand-alone function of the post-processing apparatus 200, unnecessary time consumption and power consumption may occur.

For example, referring to FIG. 1, a user of the post-processing apparatus 200 may perform a manual stapling function by using the stapling device 220. The manual stapling function refers to a function of performing a stapling operation on print media in which the print media are input to a supply portion or an inlet formed in the post-processing apparatus 200. For example, the supply portion or the inlet may be a groove or a slot formed in the post-processing apparatus 200. The manual stapling function may be regarded as a stand-alone function of the post-processing apparatus 200.

In order for the stapling device 220 to perform the manual stapling function, a user may request the manual stapling operation via an input unit 210 provided in the post-processing apparatus 200, and a sensor 230 may detect print media being input to the post-processing apparatus 200.

Hereinafter, while both the image forming apparatus 100 and the post-processing apparatus 200 are in a sleep mode, a method of using a stand-alone function of the post-processing apparatus 200 connected to the image forming apparatus 100, without releasing the sleep mode of the image forming apparatus 100, will be described. In the following description, a manual stapling function of the post-processing apparatus 200 is provided as an example of a stand-alone function of the post-processing apparatus 200.

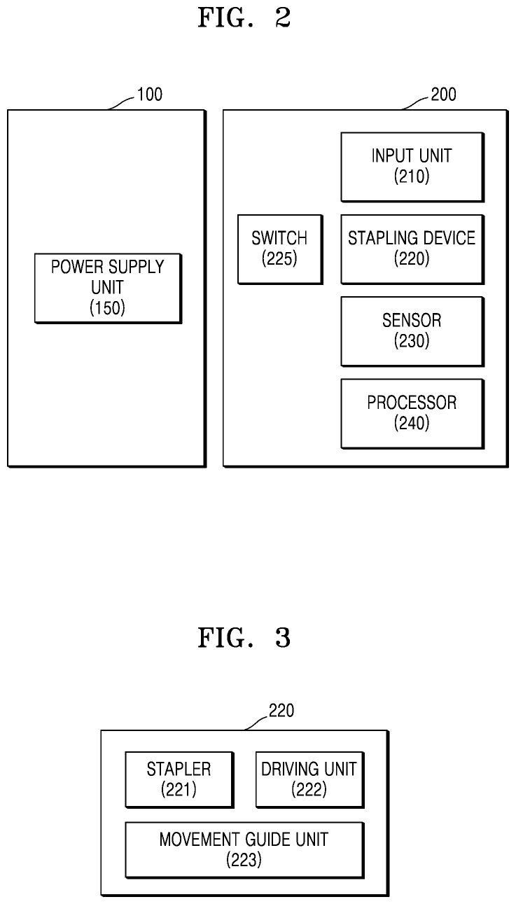

FIG. 2 is a structural block diagram of an image forming apparatus and a post-processing apparatus, according to an example. It will be obvious to one of ordinary skill in the art pertaining to the present example that other general-use elements other than the components illustrated in FIG. 2 may be further included.

Referring to FIG. 2, the image forming apparatus 100 may include a power supply unit 150. The power supply unit 150 may output power of various levels to respectively supply power of a preset level to respective components that require power. The power supply unit 150 may supply power not only to components in the image forming apparatus 100 but also to components of the post-processing apparatus 200 connected to the image forming apparatus 100. From among components of the image forming apparatus 100 and the post-processing apparatus 200, low power may be supplied to low power components, and high power may be supplied to high power components. For example, when the image forming apparatus 100 and the post-processing apparatus 200 are in the sleep mode, the power supply unit 150 may supply low power only to some components that operate with low power to continue the sleep mode of the image forming apparatus 100 and the post-processing apparatus 200.

The post-processing apparatus 200 may include the input unit 210, the stapling device 220, a switch 225, the sensor 230, and a processor 240.

The input unit 210 may be provided in the post-processing apparatus 200 and receive a request for a manual stapling operation. The input unit 210 may be in the form of a physical button located outside the post-processing apparatus 200. As a user presses the input unit 210 in the form of a physical button in the post-processing apparatus 200 that is in the sleep mode, the input unit 210 may receive a request for a manual stapling operation.

The stapling device 220 may perform a stapling function. In an example, the stapling device 220 may perform a stapling operation on print media, on which an image forming job is performed in the image forming apparatus 100 connected to the post-processing apparatus 200. In another example, a user may input print media, on which the user desires to directly perform a stapling operation, to the post-processing apparatus 200 to perform a manual stapling operation on the input print media. A location of the stapling device 220 may correspond to a position of a groove formed in the post-processing apparatus 200, into which print media may be input to perform the manual stapling operation.

The switch 225 may control whether power is supplied from the power supply unit 150 of the image forming apparatus 100, which is in the sleep mode, to the stapling device 220. According to a position of the switch 225, that is, whether the switch 225 is on or off, whether power is to be supplied from the power supply unit 150 of the image forming apparatus 100 to the stapling device 220 may be determined.

The sensor 230 may detect print media input to the post-processing apparatus 200.

The processor 240 may receive power from the power supply unit 150 of the image forming apparatus 100, which is in the sleep mode. In an example, the processor 240 may continuously receive power from the power supply unit 150 of the image forming apparatus 100, which is in the sleep mode. The input unit 210 and the sensor 230 may also receive power from the power supply unit 150 of the image forming apparatus 100 in the sleep mode. In an example, the input unit 210 and the sensor 230 may continuously receive power from the power supply unit 150 of the image forming apparatus 100 in the sleep mode.

Upon receiving a request for the manual stapling operation via the input unit 210, the processor 240 may determine this as a request to switch to a manual stapling operation mode and control the switch 225 to switch the post-processing apparatus 200 from the sleep mode to the manual stapling operation mode. To switch to the manual stapling operation, the switch 225 may be switched such that power is supplied from the power supply unit 150 to the stapling device 220. The stapling device 220 may be moved to a manual stapling operation position according to power supply from the power supply unit 150. Even when the post-processing apparatus 200 is switched to the manual stapling operation mode, the image forming apparatus 100 is maintained in the sleep mode.

Upon receiving an input detecting signal regarding print media from the sensor 230, the processor 240 may operate the stapling device 220.

The processor 240 may switch the post-processing apparatus 200 from the manual stapling operation mode to the sleep mode when certain conditions are met. According to an example, the stapling device 220 may be moved to a basic position to switch to the sleep mode. Based on the stapling device moving to the basic position, the switch 225 may be switched to block power supply from the power supply unit 150 to the stapling device 220 to switch to the sleep mode. According to another example, the stapling device 220 may not move to the basic position to switch to the sleep mode, but power supply may be blocked.

FIG. 3 is a structural block diagram of a stapling device according to an example.

Referring to FIG. 3, the stapling device 220 may include a stapler 221, a driving unit 222, and a movement guide unit 223.

The stapler 221 may perform a stapling operation on print media to bind a plurality of print media by using a staple such as a metal pin or other fastener to fix the print media.

The movement guide unit 223 is provided in the post-processing apparatus 200 to move the stapler 221 and may correspond to a path via which the stapler 221 may move. The stapler 221 may be moved to a manual stapling operation position according to the movement guide unit 223 when switched to the manual stapling operation mode.

The driving unit 222 may slide the stapler 221 along the movement guide unit 223 and operate the stapler 221.

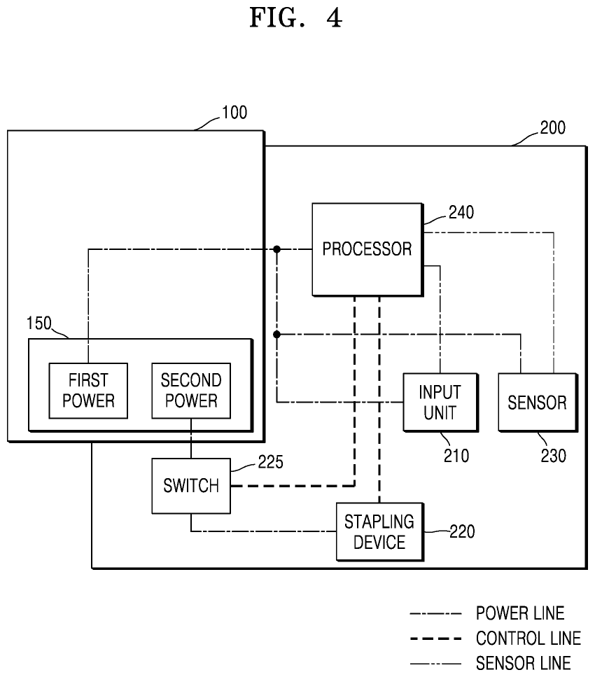

FIG. 4 is a diagram for describing an operation of an image forming apparatus and a post-processing apparatus according to an example.

Referring to FIG. 4, while the image forming apparatus 100 is maintained in the sleep mode, the post-processing apparatus 200 connected to the image forming apparatus 100 may performs a power supply, a control, and a detection operation.

The input unit 210, the sensor 230, and the processor 240 of the post-processing apparatus 200 may receive first power from the power supply unit 150 of the image forming apparatus 100 which is in the sleep mode. For example, the first power may be low power of 3.3 V. Thus, even when the post-processing apparatus 200 is in the sleep mode, the input unit 210, the sensor 230, and the processor 240 may operate by receiving the first power. Furthermore, as the first power is low power, the sleep mode of the post-processing apparatus 200 may be maintained.

The post-processing apparatus 200 may receive a request for a manual stapling operation via the input unit 210. Upon receiving the request for the manual stapling operation via the input unit 210, the processor 240 may determine the request as a request to switch to the manual stapling operation mode.

The processor 240 may control the switch 225 to switch the post-processing apparatus 200 from the sleep mode to the manual stapling operation mode. The switch 225 may be switched such that second power is supplied from the power supply unit 150 to the stapling device 220 to switch to the manual stapling operation mode. The stapling device 220 may selectively receive, from the power supply unit 150 of the image forming apparatus 100, which is in the sleep mode, second power that is higher than the first power according to an on or off state of the switch 225. For example, the second power may be a power of 24 V.

The stapling device 220 may be moved to a manual stapling operation position according to supply of the second power from the power supply unit 150. When the post-processing apparatus 200 is switched to the manual stapling operation mode, the image forming apparatus 100 may supply power to the post-processing apparatus 200 by using the power supply unit 150, but may not supply high-power to other components of the image forming apparatus 100. In that case, the image forming apparatus 100 may be maintained in the sleep mode.

The sensor 230 of the post-processing apparatus 200 switched to the manual stapling operation mode may detect print media being input to the post-processing apparatus 200.

Upon receiving an input detecting signal regarding print media from the sensor 230, the processor 240 may operate the stapling device 220.

The stapling device 220 may perform a manual stapling operation on print media to bind the print media by using a staple to fix the print media.

The processor 240 may switch the post-processing apparatus 200 from the manual stapling operation mode to the sleep mode when certain conditions are met.

For example, when a request to switch to the sleep mode is received in the manual stapling operation mode via the input unit 210 during standby for receiving an input detecting signal regarding print media via the sensor 230, the processor 240 may control the switch 225 to switch the post-processing apparatus 200 from the manual stapling operation mode to the sleep mode. When the input unit 210 is a physical button located outside the post-processing apparatus 200, and the processor 240 detects an input of the physical button in the sleep mode, the processor 240 determines that a request for a manual stapling operation is received. On the other hand, when an input of the physical button is detected in the manual stapling operation mode during standby for receiving an input detecting signal regarding print media via the sensor 230, the processor 240 may determine that a request to switch to the sleep mode is received. A duration of the input of the physical button requesting to switch to the sleep mode in the manual stapling operation mode may be longer than a duration of the input of the physical button requesting a manual stapling operation in the sleep mode.

According to an example, by using a timer provided in at least one of the post-processing apparatus 200 or the image forming apparatus 100, which is in the sleep mode, when a duration of standby for receiving an input detecting signal regarding print media via the sensor 230 in the manual stapling operation mode exceeds a certain set period, the processor 240 may control the switch 225 to switch the post-processing apparatus 200 from the manual stapling operation mode to the sleep mode. The certain set period, which is a criterion to switch from the manual stapling operation mode to the sleep mode, may be shorter than a certain set period that is a criterion for switching the post-processing apparatus 200 from the stand-by mode to the sleep mode.

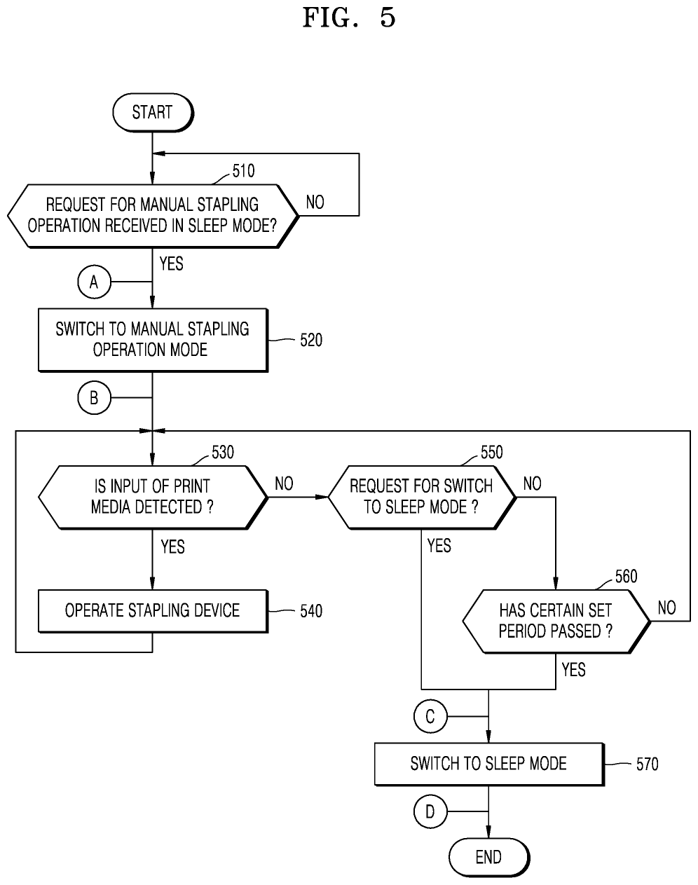

FIG. 5 is a flowchart of a method of controlling a post-processing apparatus according to an example.

Referring to FIG. 5, the post-processing apparatus 200 may determine whether a request for the manual stapling operation is received in the sleep mode in operation 510. When the request for the manual stapling operation is not received, the post-processing apparatus 200 may repeatedly perform the determination of operation 510 until the request for the manual stapling operation is received.

In operation 520, when the request for the manual stapling operation is received, the post-processing apparatus 200 may perform an operation of switching from the sleep mode to the manual stapling operation mode.

In operation 530, the post-processing apparatus 200 may determine whether input of print media to the post-processing apparatus 200 is detected in the manual stapling operation mode.

In a case in which input of the print media to the post-processing apparatus 200 is detected, the post-processing apparatus 200 may operate the stapling device 220 in operation 540.

In a case in which input of the print media to the post-processing apparatus 200 is not detected, the post-processing apparatus 200 may determine whether there is a request to switch to the sleep mode in operation 550.

In operation 560, even though there is no request to switch to the sleep mode, the post-processing apparatus 200 may determine whether a standby time to receive an input detecting signal regarding print media has passed a certain set period.

When there is no request to switch to the sleep mode in operation 550 and it is determined in operation 560 that the certain set period is not passed, the post-processing apparatus 200 may maintain the manual stapling operation mode and proceed to operation 530 to further determine whether input of print media is detected.

In operation 570, when certain conditions are met, for example, when there is a request to switch to the sleep mode in operation 550 or the certain set period is passed in operation 560, the post-processing apparatus 200 may perform an operation of switching from the manual stapling operation mode to the sleep mode.

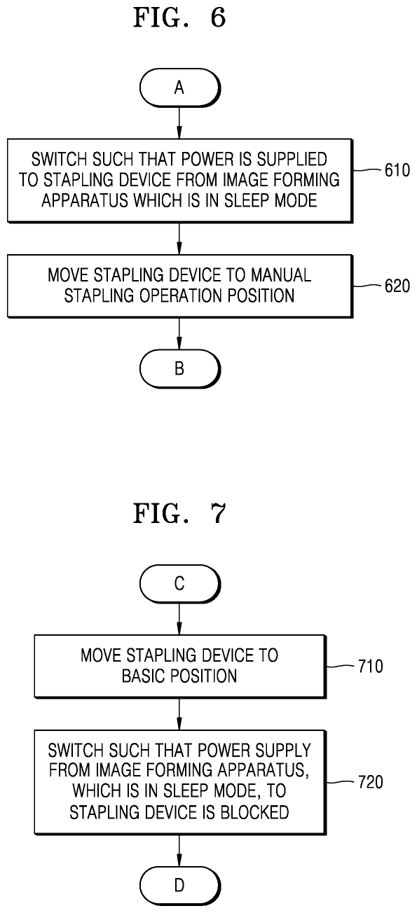

FIG. 6 is a flowchart of a method of switching to a manual stapling operation mode according to an example. An example process of switching the post-processing apparatus 200 which is in the sleep mode to the manual stapling operation mode, according to the example described with reference to FIGS. 2 through 4, is illustrated in FIG. 6.

Referring to FIG. 6, the post-processing apparatus 200 may control the switch 225 such that power is supplied from the image forming apparatus 100, which is in the sleep mode, to the stapling device 220 to switch from the sleep mode to the manual stapling operation mode in operation 610.

In operation 620, the post-processing apparatus 200 may move the stapling device 220 to a manual stapling operation position according to power supply from the image forming apparatus 100, which is in the sleep mode. Accordingly, the post-processing apparatus 200, which is in the sleep mode, is switched to the manual stapling operation mode. Even when the post-processing apparatus 200 is switched to the manual stapling operation mode, the image forming apparatus 100 is maintained in the sleep mode.

FIG. 7 is a flowchart of a method of switching to the sleep mode according to an example. An example process of switching the post-processing apparatus 200, which is in the manual stapling operation mode to the sleep mode, according to the example described with reference to FIGS. 2 through 4 is illustrated in FIG. 7.

Referring to FIG. 7, the post-processing apparatus 200 may move the stapling device 220 to a basic position to switch to the sleep mode in operation 710. However, as operation 710 may be a process that may be omitted in the post-processing apparatus 200 according to another example, the process may also immediately proceed to operation 720.

In operation 720, to switch to the sleep mode, the post-processing apparatus 200 may control the switch 225 to block power supply from the image forming apparatus 100, which is in the sleep mode, to the stapling device 220. Accordingly, the post-processing apparatus 200, which is in the manual stapling operation mode, is switched to the sleep mode.

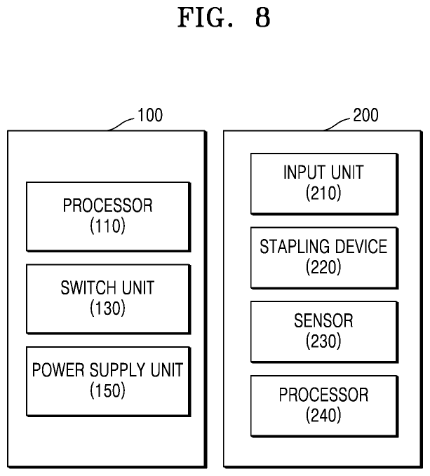

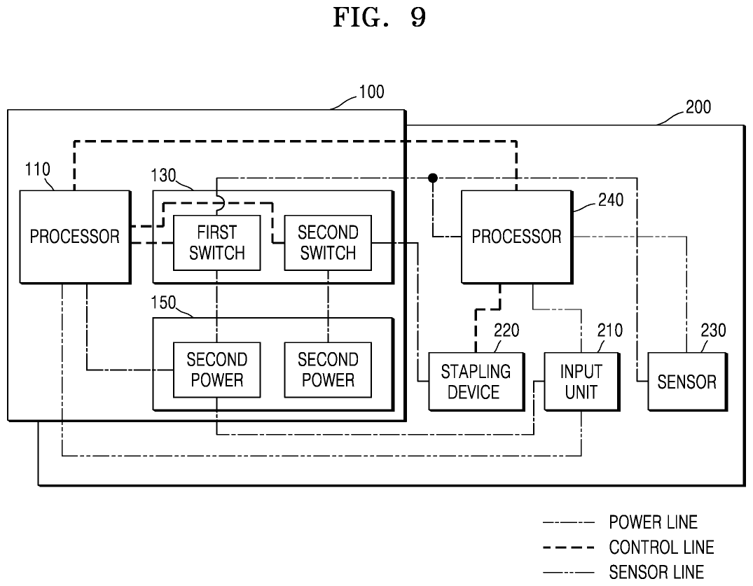

FIG. 8 is a structural block diagram of an image forming apparatus and a post-processing apparatus according to an example. It will be obvious to one of ordinary skill in the art pertaining to the present example that other general-use elements other than the components illustrated in FIG. 8 may be further included. A description provided above with reference to FIG. 2 and applying to the example of FIG. 8 will be omitted.

Referring to FIG. 8, the image forming apparatus 100 may include a processor 110, a switch unit 130, and a power supply unit 150.

By receiving low power, the processor 110 may operate even when the image forming apparatus 100 is in the sleep mode. However, when the post-processing apparatus 200 is in the sleep mode, the processor 240 of the post-processing apparatus 200 does not receive power and thus is not able to operate without the control by the processor 110 of the image forming apparatus 100.

By receiving a request for a manual stapling operation from the input unit 210 of the post-processing apparatus 200, the processor 110 in the image forming apparatus 100, which is in the sleep mode, may control to switch the post-processing apparatus 200, which is in the sleep mode, to the manual stapling operation mode. The processor 110 may control the switch unit 130 to switch the post-processing apparatus 200 from the sleep mode to the manual stapling operation mode.

The switch unit 130 may include a plurality of switches. The plurality of switches of the switch unit 130 may be respectively connected to a plurality of corresponding power supplies of the power supply unit 150 to control to supply power from the respective power supplies. According to whether each switch included in the switch unit 130 is on or off, power to be supplied from the power supply unit 150 of the image forming apparatus 100 to the post-processing apparatus 200 may be controlled.

The power supply unit 150 may output power of various levels to respectively supply power of a preset amplitude to respective components that require power. The power supply unit 150 may supply power not only to components in the image forming apparatus 100 but also to components of the post-processing apparatus 200 connected to the image forming apparatus 100. As the power supply unit 150 supplies low power to the processor 110 of the image forming apparatus 100, which is in the sleep mode, and the input unit 210 of the post-processing apparatus 200, which is in the sleep mode, the processor 110 and the input unit 210 may also operate when the image forming apparatus 100 and the post-processing apparatus 200 are in the sleep mode.

The post-processing apparatus 200 may include the input unit 210, the stapling device 220, the sensor 230, and the processor 240.

The input unit 210 may be provided in the post-processing apparatus 200 and receive a request for a manual stapling operation. In the post-processing apparatus 200, which is in the sleep mode, as a user requests a manual stapling operation, such as by pressing the input unit 210 that is in the form of a physical button to receive the request for a manual stapling operation, the request for the manual stapling operation may be transmitted to the image forming apparatus 100, which is in the sleep mode. As a response to the transmission of the request for the manual stapling operation, the image forming apparatus 100 may begin switching the post-processing apparatus 200, which is in the sleep mode, to the manual stapling operation mode.

The stapling device 220 may perform a stapling function.

As an example, the sensor 230 may detect print media being input to the post-processing apparatus 200.

The processor 240 may switch the post-processing apparatus 200 from the sleep mode to the manual stapling operation mode based on the response of the image forming apparatus 100, which is in the sleep mode.

The post-processing apparatus 200 may receive power from the power supply unit 150 of the image forming apparatus 100, which is in the sleep mode, to switch to the manual stapling operation mode. The processor 240 may receive a preparation command for the manual stapling operation from the image forming apparatus 100 according to the power supply from the power supply unit 150. The stapling device 220 may be moved to the manual stapling operation position according to the power supply from the power supply unit 150. Even when the post-processing apparatus 200 is switched to the manual stapling operation mode, the image forming apparatus 100 is maintained in the sleep mode.

Upon receiving an input detecting signal regarding print media from the sensor 230, the processor 240 may operate the stapling device 220.

The processor 240 may switch the post-processing apparatus 200 from the manual stapling operation mode to the sleep mode when certain conditions are met. According to an example, the stapling device 220 may be moved to the basic position to switch to the sleep mode. The processor 240 may inform the image forming apparatus 100 of the termination of the manual stapling operation to switch to the sleep mode. To switch to the sleep mode, the post-processing apparatus 200 may not receive power from the power supply unit 150 of the image forming apparatus 100, which is in the sleep mode. According to an example, the stapling device 220 may not be moved to the basic position but may be blocked from power supply after transmitting the termination of the manual stapling operation to the image forming apparatus 100 to switch to the sleep mode.

FIG. 9 is a diagram for describing an operation of an image forming apparatus and a post-processing apparatus according to an example. A description of elements and operations provided above with reference to FIG. 4 and applying to the example of FIG. 9 will be omitted.

Referring to FIG. 9, while the image forming apparatus 100 is maintained in the sleep mode, the post-processing apparatus 200 connected to the image forming apparatus 100 performs a power supply, a control, and a detection operation based on the control by the image forming apparatus 100, which is in the sleep mode.

The stapling device 220, the sensor 230, and the processor 240 of the post-processing apparatus 200, which is in the sleep mode, do not receive power from the power supply unit 150 of the image forming apparatus 100, which is in the sleep mode, whereas the input unit 210 receives first power from the power supply unit 150 as continuous power. For example, the first power may be low power of 3.3 V. Accordingly, even when the post-processing apparatus 200 is in the sleep mode, the input unit 210 may operate by receiving the first power, and as the first power is low power, the sleep mode of the post-processing apparatus 200 may be maintained.

The post-processing apparatus 200, which is in the sleep mode, may receive a request for the manual stapling operation via the input unit 210. In the post-processing apparatus 200, which is in the sleep mode, when the request for the manual stapling operation is received via the input unit 210, the input unit 210 may transmit the request for the manual stapling operation to the image forming apparatus 100, which is in the sleep mode. Accordingly, the processor 110 of the image forming apparatus 100, which is in the sleep mode, may detect the request for the manual stapling operation, and control to switch the post-processing apparatus 200, which is in the sleep mode, to the manual stapling operation mode.

Upon receiving the request for the manual stapling operation via the input unit 210 of the post-processing apparatus 200, the processor 110 may determine the request as a request to switch to the manual stapling operation mode.

The post-processing apparatus 200 may switch from the sleep mode to the manual stapling operation mode based on a response of the processor 110 of the image forming apparatus 100, which is in the sleep mode.

The processor 110 of the image forming apparatus 100, which is in the sleep mode, may control a first switch and a second switch included in the switch unit 130 to respectively supply first power and second power of the power supply unit 150 to the post-processing apparatus 200. The first switch may be switched such that the first power is supplied from the power supply unit 150 to the sensor 230 and the processor 240. The second switch may be switched such that the second power is supplied from the power supply unit 150 to the stapling device 220. The stapling device 220 may selectively receive, from the power supply unit 150 of the image forming apparatus 100, which is in the sleep mode, the second power according to an on or off state (i.e., a closed or an open position) of the second switch of the switch unit 130. The sensor 230 and the processor 240 may selectively receive, from the power supply unit 150 of the image forming apparatus 100, which is in the sleep mode, the first power according to an on or off state of the first switch of the switch unit 130.

The processor 240 may receive a preparation command for a manual stapling operation from the image forming apparatus 100 according to supply of the first power from the power supply unit 150. As the preparation command for a manual stapling operation is a first command after the first power is supplied to the processor 240, the processor 240 does not perform any other operation than the manual stapling operation preparation.

The stapling device 220 may be moved to the manual stapling operation position according to supply of the second power from the power supply unit 150. Even when the post-processing apparatus 200 is switched to the manual stapling operation mode, the image forming apparatus 100 may be maintained in the sleep mode.

The sensor 230 of the post-processing apparatus 200 switched to the manual stapling operation mode may detect print media being input to the post-processing apparatus 200.

Upon receiving an input detecting signal regarding print media from the sensor 230, the processor 240 may operate the stapling device 220.

The stapling device 220 may perform the manual stapling operation on the print media to bind the print media by using a staple to fix the print media.

The processor 240 may switch the post-processing apparatus 200 from the manual stapling operation mode to the sleep mode when certain conditions are met.

For example, when a request to switch to the sleep mode is received while in the manual stapling operation mode via the input unit 210 during standby for receiving an input detecting signal regarding print media via the sensor 230, the processor 240 may switch the post-processing apparatus 200 from the manual stapling operation mode to the sleep mode.

According to another example, by using a timer provided in at least one of the post-processing apparatus 200 or the image forming apparatus 100, which is in the sleep mode, when a duration of standby for receiving an input detecting signal regarding print media via the sensor 230 in the manual stapling operation mode passes a certain set period, the processor 240 may switch the post-processing apparatus 200 from the manual stapling operation mode to the sleep mode.

According to various examples of the post-processing apparatus 200, the stapling device 220 may be moved to the basic position when the post-processing apparatus 200 is switched to the sleep mode or may not be moved. The processor 240 may transmit an indication of a termination of the manual stapling operation to the image forming apparatus 100 to switch to the sleep mode. Upon receiving the indication of the termination of the manual stapling operation, the processor 110 of the image forming apparatus 100, which is in the sleep mode, may control the switch unit 130 to block power supply from the power supply unit 150 to the post-processing apparatus 200. As power supply from the power supply unit 150 to the stapling device 220, the sensor 230, and the processor 240 is blocked, the post-processing apparatus 200 may be switched to the sleep mode.

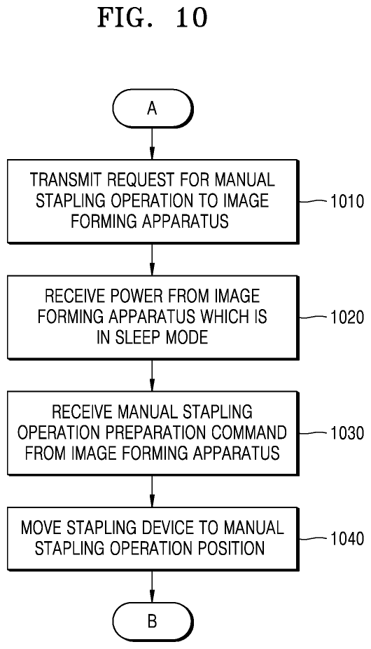

FIG. 10 is a flowchart of a method of switching to a manual stapling operation mode according to an example. An example process of switching the post-processing apparatus 200 which is in the sleep mode to the manual stapling operation mode, according to the example described with reference to FIGS. 8 and 9 is illustrated in FIG. 10.

Referring to FIG. 10, upon receiving a request for a manual stapling operation, the post-processing apparatus 200 may transmit a request for a manual stapling operation to the image forming apparatus 100, which is in the sleep mode, in operation 1010. Accordingly, control by the image forming apparatus 100 to switch the post-processing apparatus 200 in the sleep mode to the manual stapling operation mode may be started.

In operation 1020, the post-processing apparatus 200 may receive power from the image forming apparatus 100, which is in the sleep mode, to switch to the manual stapling operation mode.

In operation 1030, the post-processing apparatus 200 may receive a preparation command for the manual stapling operation from the image forming apparatus 100 according to the power supply from the image forming apparatus 100, which in the sleep mode.

In operation 1040, the post-processing apparatus 200 may move the stapling device 220 to a manual stapling operation position according to the power supply from the image forming apparatus 100, which is in the sleep mode. Accordingly, the post-processing apparatus 200, which is in the sleep mode, is switched to the manual stapling operation mode. Even when the post-processing apparatus 200 is switched to the manual stapling operation mode, the image forming apparatus 100 is maintained in the sleep mode.

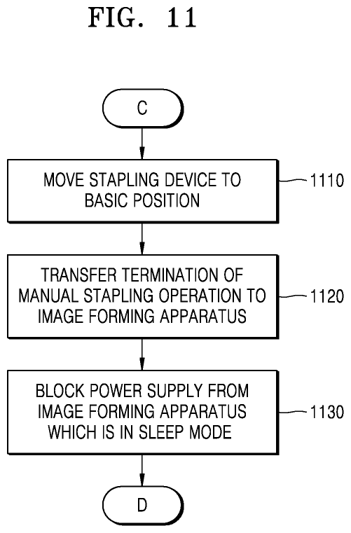

FIG. 11 is a flowchart of a method of switching to a sleep mode according to an example. An example process of switching the post-processing apparatus 200 in the manual stapling operation mode, to the sleep mode, according to the example described with reference to FIGS. 8 and 9 is illustrated in FIG. 11.

Referring to FIG. 11, the post-processing apparatus 200 may move the stapling device 220 to a basic position to switch to the sleep mode in operation 1110. However, as operation 1110 may be a process that may be omitted in the post-processing apparatus 200 according to an example, the process may also immediately proceed to operation 1120.

In operation 1120, the post-processing apparatus 200 may transfer termination of the manual stapling operation to the image forming apparatus 100 to switch to the sleep mode. As an example, the post-processing apparatus 200 may transmit an indication that the manual stapling operation is terminated to the image forming apparatus 100 to switch to the sleep mode.

In operation 1130, upon receiving the termination of the manual stapling operation, the image forming apparatus 100, which is in the sleep mode, may block power supply from the image forming apparatus 100, which is in the sleep mode, to the post-processing apparatus 200. In that case, power supply from the image forming apparatus 100 to the post-processing apparatus 200 may be blocked. Accordingly, the post-processing apparatus 200 which is in the manual stapling operation mode is switched to the sleep mode.

An example method of controlling the post-processing apparatus 200 described above may be implemented in the form of a computer-readable storage medium storing instructions or data executable by a computer or a processor. The example method of controlling the post-processing apparatus 200 described may be written as a program executable on a computer, and may be implemented on a general-purpose digital computer operating the above-described program by using a computer-readable storage medium. The computer-readable storage medium may include a read-only memory (ROM), a random-access memory (RAM), a flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks (SSDs), and any other device capable of storing instructions or software, associated data, data files, and data structures and providing instructions or software, associated data, data files, and data structures to a processor or a computer to execute these instructions or software, associated data, data files, and data structures.

What is claimed is:

1. A post-processing apparatus connected to an image forming apparatus, the post-processing apparatus comprising:
an input unit to receive a request for a manual stapling operation;
a stapling device;
a switch to control power supplied from the image forming apparatus in a sleep mode to the stapling device;
a sensor to detect print media being input to the post-processing apparatus; and
a processor to:
receive power from the image forming apparatus, which is in the sleep mode,
control the switch to switch the post-processing apparatus from the sleep mode to a manual stapling operation mode when the request for the manual stapling operation is received via the input unit, and
operate the stapling device when an input detection signal regarding the print media is received from the sensor.

2. The post-processing apparatus of claim 1,
wherein the processor is to control the switch to supply power from the image forming apparatus in the sleep mode to the stapling device to switch to the manual stapling operation mode, and
wherein the stapling device is moved to a manual stapling operation position according to the supplied power.

3. The post-processing apparatus of claim 1, wherein the input unit, the sensor, and the processor continuously receive first power from the image forming apparatus which is in the sleep mode.

4. The post-processing apparatus of claim 3, wherein the stapling device selectively receives second power, which is greater than the first power, from the image forming apparatus which is in the sleep mode, according to the control of the switch.

5. The post-processing apparatus of claim 1, wherein, when the processor is to switch the post-processing apparatus from the manual stapling operation mode to the sleep mode according to fulfillment of certain conditions, the processor is to control the switch to block power supplied from the image forming apparatus, which is in the sleep mode, to the stapling device to switch to the sleep mode.

6. The post-processing apparatus of claim 1, wherein, when a request to switch to the sleep mode is received via the input unit in the manual stapling operation mode during standby for receiving the input detection signal via the sensor, the processor is to control the switch to switch the post-processing apparatus from the manual stapling operation mode to the sleep mode.

7. The post-processing apparatus of claim 6,
wherein the input unit includes a physical button located outside the post-processing apparatus,
wherein the processor is to determine that the request for a manual stapling operation is received when an input of the physical button is detected in the sleep mode, and
wherein, when the input of the physical button is detected in the manual stapling operation mode during standby for receiving the input detecting signal via the sensor, the processor is to determine that the request for the switch to the sleep mode is received.

8. The post-processing apparatus of claim 7, wherein a duration of the input of the physical button requesting the switch to the sleep mode in the manual stapling operation mode is longer than a duration of the input of the physical button requesting the manual stapling operation in the sleep mode.

9. The post-processing apparatus of claim 1, wherein
the processor is to use a timer provided in at least one of the post-processing apparatus or the image forming apparatus, which is in the sleep mode, to control the switch to switch the post-processing apparatus from the manual stapling operation mode to the sleep mode when a duration of standby for receiving the input detecting signal via the sensor in the manual stapling operation mode exceeds a certain set period.

10. The post-processing apparatus of claim 9, wherein the certain set period, which is a criterion for the switch from the manual stapling operation mode to the sleep mode, is shorter than a certain set period that is a criterion to switch the post-processing apparatus from a stand-by mode to the sleep mode.

11. A post-processing apparatus connected to an image forming apparatus, the post-processing apparatus comprising:
an input unit to receive a request for a manual stapling operation;
a stapling device;
a sensor to detect print media being input to the post-processing apparatus; and
a processor to:
transmit a request for the manual stapling operation to the image forming apparatus, which is in a sleep mode,
when the request for the manual stapling operation is received via the input unit, switch the post-processing apparatus from the sleep mode to a manual stapling operation mode based on a response of the image forming apparatus, which is in the sleep mode, and
operate the stapling device when an input detecting signal regarding the print media is received from the sensor.

12. The post-processing apparatus of claim 11,
wherein the post-processing apparatus is to receive power from the image forming apparatus, which is in the sleep mode, to switch to the manual stapling operation mode,
wherein the processor is to receive a preparation command for the manual stapling operation from the image forming apparatus according to a power supply, and
wherein the stapling device is moved to a manual stapling operation position according to the power supply.

13. The post-processing apparatus of claim 11, wherein, when the processor switches the post-processing apparatus from the manual stapling operation mode to the sleep mode according to fulfillment of certain conditions, the processor is to transfer termination of a manual stapling operation to the image forming apparatus to switch to the sleep mode, and
power supply is blocked to the post-processing apparatus from the image forming apparatus, which is in the sleep mode, to switch to the sleep mode.

14. The post-processing apparatus of claim 11, wherein the processor is to switch the post-processing apparatus from the manual stapling operation mode to the sleep mode when a request for a switch to the sleep mode is received in the manual stapling operation mode via the input unit during standby for receiving the input detection signal via the sensor.

15. The post-processing apparatus of claim 11, wherein the processor is to use a timer provided in at least one of the post-processing apparatus or the image forming apparatus, which is in the sleep mode, to switch the post-processing apparatus from the manual stapling operation mode to the sleep mode when a duration of standby for receiving the input detecting signal via the sensor in the manual stapling operation mode passes a certain set period.
